(19) United States
(12) Patent Application Publication
(10) Pub. No.: US 2022/0333646 A1
(43) Pub. Date: Oct. 20, 2022

(54) Rotary Table Bearing and Rotary Table

(71) Applicant: NIPPON THOMPSON CO., LTD., Tokyo (JP)

(72) Inventor: Tomoaki NAKAMURA, Mino-shi, Gifu (JP)

(21) Appl. No.: 17/641,661

(22) PCT Filed: Aug. 18, 2020
(86) PCT No.: PCT/JP2020/031180

§ 371 Date: Mar. 9, 2022

(30) Foreign Application Priority Data
Sep. 13, 2019 (JP) 2019-167039

(51) Int. Cl. F16C 33/58; F16C 19/36

(52) U.S. Cl. CPC F16C 33/583; F16C 19/36

(57) ABSTRACT

A rotary table bearing 1 includes an outer ring 10, an inner ring 20, and a plurality of rollers 30. The outer ring 10 includes a first body portion 11 and a first steel strip 12. The inner ring 20 includes a second body portion 21 and a second steel strip 22. The first body portion 11 includes a first flange portion 53 of an annular shape that contacts a first end face 31 which is an end face of the roller 30 in the axial direction. The second body portion 21 includes a second flange portion 54 of an annular shape that is located to contact a second end face 32 which is an end face of the roller 30 opposite to the first end face 31 in the axial direction. At least one of an inner circumferential surface of the inner ring 20 and an outer circumferential surface of the outer ring 10 has a gear 114 formed over an entire circumference thereof.

### TECHNICAL FIELD

The present invention relates to a bearing for a rotary table and a rotary table. The present application claims priority based on Japanese Patent Application No. 2019-167039 filed on Sep. 13, 2019, the entire contents of which are incorporated herein by reference.

### BACKGROUND ART

A slewing or slewing bearing may be used for a rotary table in an analyzer (see, for example, Patent Literature 1).

### CITATION LIST

### Patent Literature

Patent Literature 1: Japanese Patent Application Laid-Open No. 2017-090353

### SUMMARY OF INVENTION

### Technical Problem

In a slewing bearing having balls as the rolling elements, axial internal clearance causes misalignment of the outer ring with respect to the inner ring in the axial direction. Further, axial runout of the outer ring with respect to the inner ring may occur. The larger the diameter of the slewing bearing, the more difficult it becomes to precisely machine the rolling surfaces of the outer and inner rings, leading to an increased production cost.

Therefore, one of the objects is to provide a rotary table bearing and a rotary table that can suppress misalignment of the outer ring with respect to the inner ring in the axial direction and the axial runout, and also reduce the production cost.

### Solution to Problem

A bearing for a rotary table according to the present disclosure includes: an outer ring having an annular first rolling surface; an inner ring having an annular second rolling surface, the second rolling surface having a common central axis with the first rolling surface, located on an inner circumference side of the outer ring, and facing the first rolling surface; and a plurality of rollers arranged to be capable of rolling on the first and second rolling surfaces. The outer ring includes a first body portion of an annular shape, and a first steel strip of an annular shape held in the first body portion and having a first inner circumferential surface constituting the first rolling surface. The inner ring includes a second body portion of an annular shape, and a second steel strip of an annular shape held in the second body portion and having a second outer circumferential surface constituting the second rolling surface. The first body portion includes a first flange portion of an annular shape protruding radially inward from one side in the axial direction of the first steel strip and contacting a first end face which is an end face of the roller in the axial direction. The second body portion includes a second flange portion of an annular shape protruding radially outward from one side in the axial direction of the second steel strip and located to contact a second end face which is an end face of the roller opposite to the first end face in the axial direction. At least one of an inner circumferential surface of the inner ring and an outer circumferential surface of the outer ring has a gear formed over an entire circumference thereof.

### Advantageous Effects of Invention

According to the above-described rotary table bearing and rotary table, misalignment of the outer ring with respect to the inner ring in the axial direction and the axial runout can be suppressed, and the production cost can also be reduced.

### BRIEF DESCRIPTION OF DRAWINGS

FIG. 1 is a schematic perspective view showing the structure of a rotary table bearing in Embodiment 1;

FIG. 2 is a schematic cross-sectional view showing the structure of the rotary table bearing in Embodiment 1;

FIG. 3 is a schematic perspective view showing the structure of a first steel strip;

FIG. 4 is a schematic enlarged perspective view of a portion of the first steel strip in FIG. 3;

FIG. 5 is a schematic perspective view showing the structure of a second steel strip;

FIG. 6 is a schematic enlarged perspective view of a portion of the second steel strip in FIG. 5;

FIG. 7 is a schematic perspective view showing the structure of a retainer;

FIG. 8 is a schematic enlarged perspective view of a portion of the retainer in FIG. 7;

FIG. 9 is a schematic perspective view showing the structure of a rotary table bearing in Embodiment 2;

FIG. 10 is a schematic cross-sectional view showing the structure of the rotary table bearing in Embodiment 2;

FIG. 11 is a schematic perspective view showing the structure of a first member;

FIG. 12 is a schematic plan view showing the structure of the first member;

FIG. 13 is a schematic perspective view showing the state where the first member is attached to a second body portion;

FIG. 14 is a schematic perspective view showing the structure of a rotary table in Embodiment 3; and

FIG. 15 is a schematic cross-sectional view showing the structure of the rotary table in Embodiment 3.

### DESCRIPTION OF EMBODIMENTS

### Outline of Embodiments

First, embodiments of the present disclosure will be listed and described. A bearing for a rotary table of the present disclosure includes: an outer ring having an annular first rolling surface; an inner ring having an annular second rolling surface, the second rolling surface having a common central axis with the first rolling surface, located on an inner circumference side of the outer ring, and facing the first rolling surface; and a plurality of rollers arranged to be capable of rolling on the first and second rolling surfaces. The outer ring includes a first body portion of an annular shape, and a first steel strip of an annular shape held in the first body portion and having a first inner circumferential surface constituting the first rolling surface. The inner ring includes a second body portion of an annular shape, and a second steel strip of an annular shape held in the second body portion and having a second outer circumferential surface constituting the second rolling surface. The first body portion includes a first flange portion of an annular shape protruding radially inward from one side in the axial direction of the first steel strip and contacting a first end face which is an end face of the roller in the axial direction. The second body portion includes a second flange portion of an annular shape protruding radially outward from one side in the axial direction of the second steel strip and located to contact a second end face which is an end face of the roller opposite to the first end face in the axial direction. At least one of an inner circumferential surface of the inner ring and an outer circumferential surface of the outer ring has a gear formed over an entire circumference thereof.

In the rotary table bearing in the present disclosure, rollers are adopted as the rolling elements. The first body portion includes the first flange portion that contacts the first end face of the roller. The second body portion includes the second flange portion that contacts the second end face of the roller. By adopting the rollers as the rolling elements and including the first and second flange portions, misalignment of the outer ring with respect to the inner ring in the axial direction and the axial runout can be suppressed. Adopting the rollers as the rolling elements and using the first steel strip having the first inner circumferential surface that constitutes the first rolling surface and the second steel strip having the second outer circumferential surface that constitutes the second rolling surface can eliminate the need to machine the rolling surfaces into a precise curved surface in the axial direction, thereby reducing the production cost. In particular, in the case where the diameter of the rotary table bearing is large (e.g., the outer ring has an outer diameter of 400 mm or more), it may be difficult to precisely machine the rolling surfaces. In such a case, the rotary table bearing of the present disclosure will have a greater effect of reducing the production cost. As such, according to the rotary table bearing of the present disclosure, misalignment of the outer ring with respect to the inner ring in the axial direction and the axial runout can be suppressed, and the production cost can also be reduced.

In the above rotary table bearing, the first body portion may further include a third flange portion protruding radially inward from another side in the axial direction of the first steel strip, the third flange portion being arranged spaced apart from the first flange portion in the axial direction and facing the second end face of the roller. The second body portion may further include a fourth flange portion protruding radially outward from another side in the axial direction of the second steel strip, the fourth flange portion being arranged spaced apart from the second flange portion in the axial direction and facing the first end face of the roller. Thus including the third and fourth flange portions can further suppress the misalignment of the outer ring with respect to the inner ring in the axial direction and the axial runout.

In the above rotary table bearing, a portion including the third flange portion may be detachable from another portion of the first body portion. That the portion including the third flange portion is detachable facilitates assembly of the rotary table bearing.

In the above rotary table bearing, a portion including the fourth flange portion may be detachable from another portion of the second body portion. That the portion including the fourth flange portion is detachable facilitates assembly of the rotary table bearing.

The above rotary table bearing may further include a retainer that retains the plurality of rollers at predetermined intervals. The inclusion of such a retainer can suppress the contact between the rollers.

In the above rotary table bearing, the retainer may have an annular shape. The retainer may have a plurality of cutouts formed at equal intervals in the circumferential direction, each cutout extending in the axial direction and having an opening at one end face. The rollers may be retained in the cutouts in such a manner that the rollers and the cutouts correspond one-to-one with each other. A retainer having a plurality of cutouts as described above is suitable as a retainer for a rotary table bearing.

In the above rotary table bearing, at least one of the first steel strip and the second steel strip may be divided into a plurality of pieces in the circumferential direction. Adopting the above configuration facilitates the mounting of the first steel strip to the first body portion. Similarly, it facilitates the mounting of the second steel strip to the second body portion.

In the above rotary table bearing, at least one of the first steel strip and the second steel strip may include a first portion and a second portion arranged side by side in the circumferential direction. A virtual plane containing end faces in the circumferential direction of the first and second portions may intersect a rotational axis of the rotary table bearing. Adopting the above configuration in the first and second portions can suppress the dropping of the roller from the boundary between the first and second portions.

In the above rotary table bearing, the outer ring may have an outer diameter of at least 400 mm. An outer ring with an outer diameter of 400 mm or more is suitable as an outer ring in a rotary table bearing.

In the above rotary table bearing, a region including the first inner circumferential surface of the first steel strip may have a hardness of at least 55 HRC, and a region including the second outer circumferential surface of the second steel strip may have a hardness of at least 55 HRC. The first and second steel strips with a hardness of 55 HRC or higher in the above regions have a sufficiently hard surface, so they are suitable as the first and second steel strips in a rotary table bearing.

A rotary table in the present disclosure includes: the rotary table bearing described above; and a retaining member disposed on an end face in the axial direction of one of the first and second body portions, the retaining member having retaining portions configured to retain other members at equal intervals in the circumferential direction. As the rotary table of the present disclosure includes the above rotary table bearing, misalignment of the inner ring with respect to the outer ring in the axial direction and the axial runout can be suppressed, and the production cost can also be reduced. The rotary table of the present disclosure enables stable turning of the retaining member.

### DESCRIPTION OF SPECIFIC EMBODIMENTS

Specific embodiments of the rotary table bearing and the rotary table of the present disclosure will be described below with reference to the drawings. In the drawings referenced below, the same or corresponding portions are denoted by the same reference numerals and the description thereof will not be repeated.

### Embodiment 1

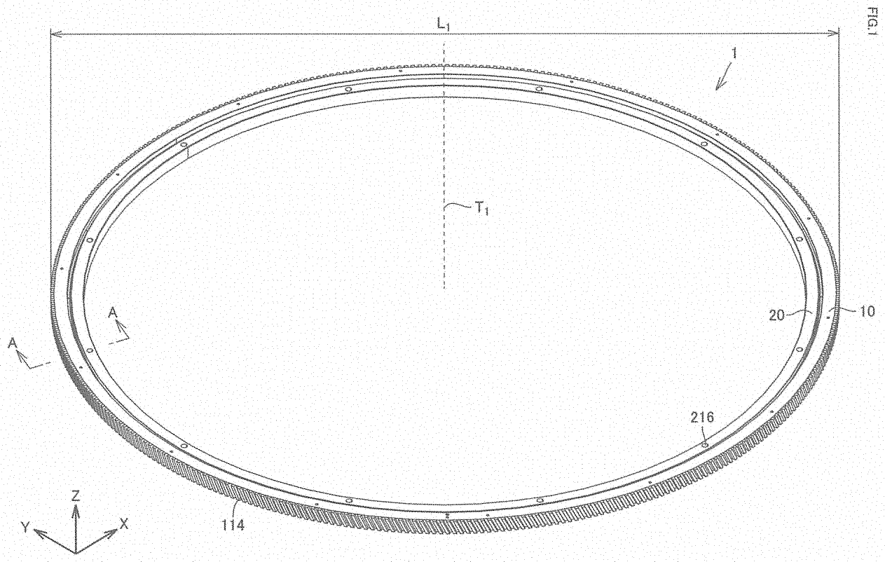

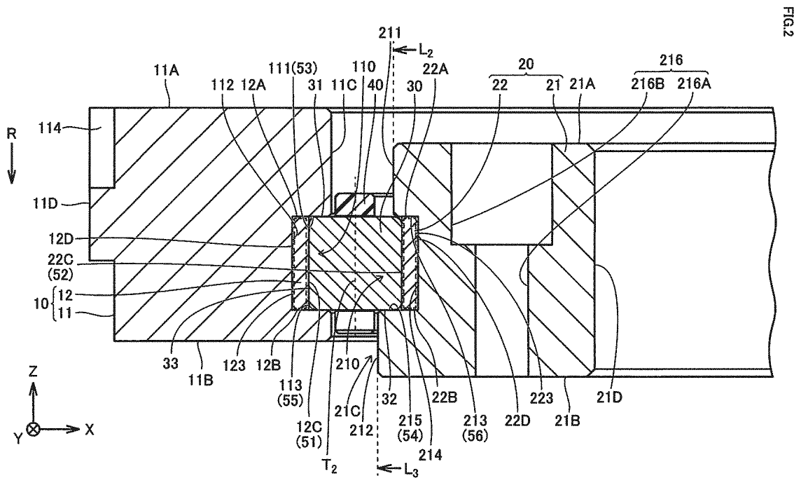

FIG. 1 is a schematic perspective view showing the structure of a rotary table bearing in Embodiment 1. In FIG. 1, the Z axis direction is along the direction (axial direction) in which a rotational axis T₁ of the rotary table bearing 1 extends. FIG. 2 is a cross-sectional view when cut at A-A in FIG. 1. Referring to FIGS. 1 and 2, the rotary table bearing 1 in Embodiment 1 includes an outer ring 10, an inner ring 20, a plurality of rollers 30, and a retainer 40. The rotary table bearing 1 in the present embodiment is a bearing used for a rotary table in an analyzer or the like.

The outer ring 10 includes a first body portion 11 and a first steel strip 12. In the present embodiment, the outer ring 10 has an outer diameter L₁ of 400 mm or more. The outer diameter L₁ of the outer ring 10 is preferably 400 mm or more and 1000 mm or less, and more preferably 400 mm or more and 900 mm or less.

The first body portion 11 has an annular shape. In the present embodiment, the first body portion 11 is made of steel having a pearlite structure. That is, the first body portion 11 has not undergone quench hardening. The steel that constitutes the first body portion 11 in the present embodiment is, for example, S45C specified in JIS standard. The first body portion 11 includes one end face 11A, an end face 11B on the opposite side of the end face 11A in the Z axis direction, an inner circumferential surface 11C, and an outer circumferential surface 11D. The end faces 11A and 11B each have a planar shape. The end face 11A and the end face 11B are arranged in parallel. The inner circumferential surface 11C has an annularly recessed first concave portion 110 formed on the end face 11B side than its center in the Z axis direction. The first concave portion 110 extends along the circumferential direction of the inner circumferential surface 11C. The first concave portion 110 is defined by a first surface 111, a second surface 112, and a third surface 113, which are of annular shape. The first surface 111 and the third surface 113 each have a planar shape. The second surface 112 has a cylindrical surface shape. The second surface 112 preferably has a ratio (Ra/Rz) of the value of arithmetic mean roughness Ra to the value of maximum height roughness Rz of 0.15 or more and 0.3 or less. The above Ra and Rz are measured in accordance with JIS B 0601:2013. The first surface 111 and the third surface 113 are spaced apart in the Z axis direction. The first surface 111 and the third surface 113 are arranged in parallel. The third surface 113 is located on the end face 11B side in the Z axis direction when viewed from the first surface 111. The second surface 112 is connected to the outer perimeters of the first surface 111 and the third surface 113. The second surface 112 is located parallel to the Z axis direction. A gear 114 is formed over the entire circumference to include the outer circumferential surface 11D of the first body portion 11. In the present embodiment, the gear 114 is a helical gear. For example, the first body portion 11 is subjected to grinding to form the gear 114.

The first steel strip 12 has an annular shape. The material that constitutes the first steel strip 12 in the present embodiment is a steel material that has undergone nitrocarburizing treatment on its surface. The steel constituting the first steel strip 12 in the present embodiment is, for example, SCM415 specified in JIS standard. The first steel strip 12 has one end face 12A, an end face 12B on the opposite side of the end face 12A in the Z axis direction, a first inner circumferential surface 12C, and a first outer circumferential surface 12D. The first steel strip 12 in the present embodiment has a nitrocarburized layer 123 arranged to include the surface. With this, a region including the first inner circumferential surface 12C of the first steel strip 12 has a hardness (Rockwell hardness) of 55 HRC or higher. The hardness of the region including the first inner circumferential surface 12C is preferably 58 HRC or higher. The end face 12A and the end face 12B are arranged in parallel. The first inner circumferential surface 12C and the first outer circumferential surface 12D are of concentric cylindrical surface shape. The first outer circumferential surface 12D is located to contact the second surface 112. The end face 12A of the first steel strip is located to contact the first surface 111. The end face 12B of the first steel strip is located to contact the third surface 113. The first steel strip 12 is held in the first body portion 11 in the state of being fitted in the first concave portion 110.

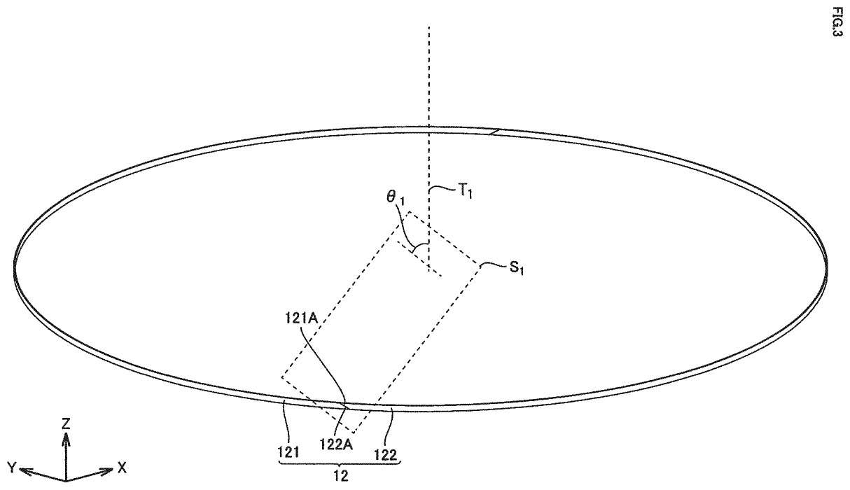

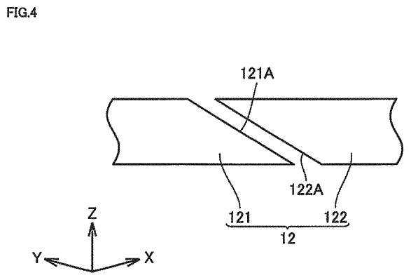

FIG. 3 is a schematic perspective view of the first steel strip 12. FIG. 4 is a perspective diagram showing, in enlarged view, the area around end faces in the circumferential direction of a first portion 121 and a second portion 122 of the first steel strip 12 in FIG. 3. Referring to FIGS. 3 and 4, in the present embodiment, the first steel strip 12 is divided into a plurality of pieces in the circumferential direction. The first steel strip 12 in the present embodiment is divided into two portions. The first steel strip 12 includes a first portion 121 and a second portion 122. The first portion 121 and the second portion 122 are arranged side by side in the circumferential direction. One end face 121A in the circumferential direction of the first portion 121 and one end face 122A in the circumferential direction of the second portion 122 are located to face each other with a small interval (of, e.g., 1 mm or less) therebetween. In the present embodiment, the end face 121A and the end face 122A are arranged in parallel. A virtual plane S₁ containing the end faces 121A and 122A intersects a rotational axis T₁ of the rotary table bearing 1.

Referring to FIGS. 1 and 2, the inner ring 20 includes a second body portion 21 and a second steel strip 22. The second body portion 21 has an outer shape of an annular form. The second body portion 21 is made of steel having a pearlite structure. That is, the second body portion 21 in the present embodiment has not undergone quench hardening. The steel constituting the second body portion 21 in the present embodiment is, for example, S45C specified in JIS standard. The second body portion 21 includes one end face 21A, an end face 21B on the opposite side of the end face 21A in the Z axis direction, an outer circumferential surface 21C, and an inner circumferential surface 21D. The end faces 21A and 21B each have a planar shape. The end face 21A and the end face 21B are arranged in parallel. The inner circumferential surface 21D has a cylindrical surface shape. The outer circumferential surface 21C includes a first region 211 located on the end face 21A side than its center in the Z axis direction, and a second region 212 located on the end face 21B side than its center in the Z axis direction. The first region 211 has an outer diameter L₂ that is smaller than an outer diameter L₃ of the second region 212.

The outer circumferential surface 21C has an annularly recessed second concave portion 210 formed between the first region 211 and the second region 212 in the Z axis direction. The second concave portion 210 extends along the circumferential direction of the outer circumferential surface 21C. The second concave portion 210 is defined by a fourth surface 213, a fifth surface 214, and a sixth surface 215, which are of annular shape. The fourth surface 213 and the sixth surface 215 each have a planar shape. The fifth surface 214 has a cylindrical surface shape. The fifth surface 214 preferably has a ratio (Ra/Rz) of the value of arithmetic mean roughness Ra to the value of maximum height roughness Rz of 0.15 or more and 0.3 or less. The above Ra and Rz are measured in accordance with JIS B 0601:2013. The fourth surface 213 and the sixth surface 215 are spaced apart in the Z axis direction. The fourth surface 213 and the sixth surface 215 are arranged in parallel. The sixth surface 215 is located on the end face 21B side in the Z axis direction when viewed from the fourth surface 213. The fifth surface 214 is connected to the inner perimeters of the fourth surface 213 and the sixth surface 215. The fifth surface 214 is located parallel to the Z axis direction. The second body portion 21 has a plurality of screw portions 216 formed at intervals in the circumferential direction to penetrate from the end face 21A to the end face 21B. Each screw portion 216 has a screw hole portion 216A and a counterbored portion 216B. The screw hole portion 216A is surrounded by a wall surface having a helical threaded groove. The counterbored portion 216B communicates with the screw hole portion 216A in the axial direction, has a diameter larger than that of the screw hole portion 216A, and is surrounded by a wall surface of a cylindrical surface shape. The opening of the screw hole portion 216A on the opposite side of the counterbored portion 216B in the Z axis direction is formed on the end face 21B. The opening of the counterbored portion 216B on the opposite side of the screw hole portion 216A in the Z axis direction is formed on the end face 21A. The end face 21A of the second body portion 21 is located on the end face 11A side than the center of the inner circumferential surface 11C in the Z axis direction of the first body portion 11. The end face 11B of the first body portion 11 is located on the end face 21B side than the center of the outer circumferential surface 21C in the Z axis direction of the second body portion 21.

The second steel strip 22 has an annular shape. The material that constitutes the second steel strip 22 in the present embodiment is a steel material that has undergone nitrocarburizing treatment on its surface. The steel constituting the second steel strip 22 in the present embodiment is, for example, SCM415 specified in JIS standard. The second steel strip 22 includes one end face 22A, an end face 22B on the opposite side of the end face 22A in the Z axis direction, a second outer circumferential surface 22C, and a second inner circumferential surface 22D. The second steel strip 22 has a nitrocarburized layer 223 arranged to include the surface. With this, a region including the second outer circumferential surface 22C of the second steel strip 22 has a hardness (Rockwell hardness) of 55 HRC or higher. The hardness of the region including the second outer circumferential surface 22C is preferably 58 HRC or higher. The end face 22A and the end face 22B are arranged in parallel. The second outer circumferential surface 22C and the second inner circumferential surface 22D are of concentric cylindrical surface shape. The second inner circumferential surface 22D is located to contact the fifth surface 214. The end face 22A of the second steel strip 22 is located to contact the fourth surface 213. The end face 22B of the second steel strip 22 is located to contact the sixth surface 215. The second steel strip 22 is held in the second body portion 21 in the state of being fitted in the second concave portion 210.

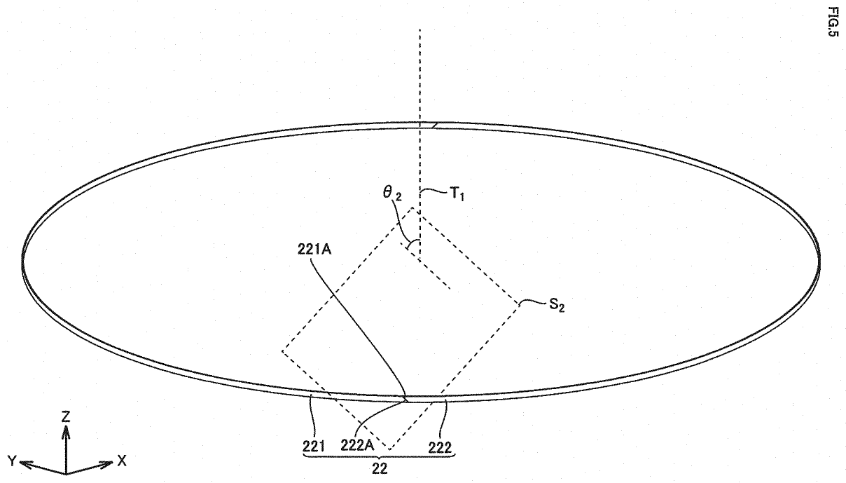

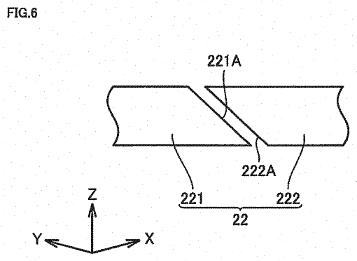

FIG. 5 is a schematic perspective view of the second steel strip 22. FIG. 6 is a perspective diagram showing, in enlarged view, the area around end faces in the circumferential direction of a first portion 221 and a second portion 222 of the second steel strip 22 in FIG. 5. Referring to FIGS. 5 and 6, in the present embodiment, the second steel strip 22 is divided into a plurality of pieces in the circumferential direction. The second steel strip 22 in the present embodiment is divided into two portions. The second steel strip 22 includes a first portion 221 and a second portion 222. The first portion 221 and the second portion 222 are arranged side by side in the circumferential direction. One end face 221A in the circumferential direction of the first portion 221 and one end face 222A in the circumferential direction of the second portion 222 are located to face each other with a small interval (of, e.g., 1 mm or less) therebetween. A virtual plane S₂ containing the end faces 221A and 222A intersects the rotational axis T₁ of the rotary table bearing 1. In the present embodiment, the virtual plane S₂ has an angle θ₂ to the rotational axis T₁ that is different from an angle θ₁ of the virtual plane S₁ to the rotational axis T₁ (see FIGS. 3 and 5). This facilitates distinguishing between the first steel strip 12 and the second steel strip 22 at the time of assembling the rotary table bearing 1.

Referring to FIG. 2, a roller 30 has a cylindrical shape. The roller 30 in the present embodiment is made of steel. In the present embodiment, the steel that constitutes the roller 30 is, for example, SUJ2 specified in JIS standard. The roller 30 includes a first end face 31, which is one end face, a second end face 32 on the opposite side of the first end face 31 in the axial direction, and an outer circumferential surface 33 of a cylindrical surface shape that connects the first end face 31 and the second end face 32. A plurality of rollers 30 are disposed apart from each other in the circumferential direction. Each roller 30 is arranged such that the direction in which a rotational axis T₂ of the roller 30 extends coincides with the Z axis direction. The plurality of rollers 30 are arranged such that they can roll while contacting the first inner circumferential surface 12C and the second outer circumferential surface 22C at their outer circumferential surfaces 33. That is, the first inner circumferential surface 12C constitutes the first rolling surface 51. The second outer circumferential surface 22C constitutes the second rolling surface 52.

Each roller 30 is arranged such that the first end face 31 is in contact with the first surface 111 of the first body portion 11. The first end face 31 and the fourth surface 213 of the second body portion are arranged to be at the same height in the Z axis direction. The roller 30 is arranged such that the second end face 32 is in contact with the sixth surface 215 of the second body portion 21. The second end face 32 and the third surface 113 of the first body portion 11 are arranged to be at the same height in the Z axis direction. The first surface 111 constitutes a first flange portion 53 that protrudes radially inward from the end face 12A side of the first steel strip 12. The sixth surface 215 constitutes a second flange portion 54 that protrudes radially outward from the end face 22B side of the second steel strip 22. The third surface 113 constitutes a third flange portion 55 that protrudes radially inward from the end face 12B side of the first steel strip 12. The fourth surface 213 constitutes a fourth flange portion 56 that protrudes radially outward from the end face 22A side of the second steel strip 22.

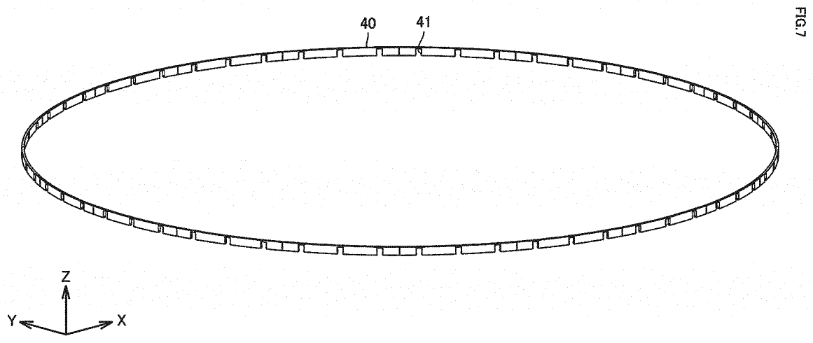

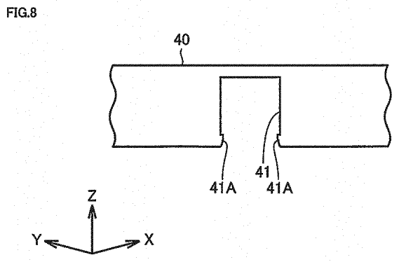

FIG. 7 is a schematic perspective view of the retainer 40. FIG. 8 is a perspective diagram showing, in enlarged view, the area around a cutout of the retainer 40 in FIG. 7. Referring to FIGS. 2, 7, and 8, the retainer 40 has an annular shape. In the present embodiment, the retainer 40 is made of resin. In the present embodiment, the retainer 40 is divided into a plurality of pieces (20 pieces in the present embodiment) in the circumferential direction. The retainer 40 is placed between the first body portion 11 and the second body portion 21 in the radial direction. The retainer 40 is arranged to hold the plurality of rollers 30 at predetermined intervals. The retainer 40 has a plurality of cutouts 41 formed at intervals in the circumferential direction, each cutout extending in the axial direction and having an opening on one end face. In the present embodiment, the plurality of cutouts 41 are formed at equal intervals in the circumferential direction. In the present embodiment, the retainer 40 has a pair of protruding portions 41A in a region on the opening side of each cutout 41, the portions protruding to face each other in the circumferential direction. The rollers 30 are held in the cutouts 41 in such a manner that the rollers 30 and the cutouts 41 correspond one-to-one with each other.

Here, the rotary table bearing 1 in the present embodiment adopts the rollers 30 as the rolling elements and includes the first surface 111 as the first flange portion 53 and the sixth surface 215 as the second flange portion 54. This can suppress misalignment of the outer ring 10 with respect to the inner ring 20 in the axial direction (Z axis direction) and the axial runout. Further, adopting the rollers 30 as the rolling elements and adopting steel having a sufficiently hard surface as the steel constituting the first steel strip 12 and the second steel strip 22 can eliminate the need to machine the rolling surfaces into a precise curved surface in the axial direction, thereby reducing the production cost. As such, according to the rotary table bearing 1 in the present embodiment, misalignment of the outer ring 10 with respect to the inner ring 20 in the axial direction and the axial runout can be suppressed, and the production cost can also be reduced.

In the above embodiment, when the second body portion 21 is fixed to a member that holds the rotary table bearing 1, the first end face 31 of the roller 30 contacts the first flange portion 53 in the first body portion 11, and the second end face 32 of the roller 30 contacts the second flange portion 54 in the second body portion 21, thereby restricting the first body portion 11 from moving in the direction of the arrow R. This enables the outer ring 10 to rotate in the circumferential direction with respect to the inner ring 20.

In the above embodiment, the first body portion 11 includes the third surface 113 as the third flange portion 55 that protrudes radially inward from the end face 12B side of the first steel strip 12, is spaced apart in the Z axis direction from the first surface 111, and faces the second end face 32 of the roller 30. The second body portion 21 includes the fourth surface 213 as the fourth flange portion 56 that protrudes radially outward from the end face 22A side of the second steel strip 22, is spaced apart in the Z axis direction from the sixth surface 215, and faces the first end face 31 of the roller 30. Such inclusion of the third flange portion 55 and the fourth flange portion 56 can further suppress the misalignment of the outer ring 10 with respect to the inner ring 20 in the axial direction and the axial runout.

In the above embodiment, the first steel strip 12 and the second steel strip 22 are divided into a plurality of pieces in the circumferential direction. Adopting the above configuration in the first steel strip 12 and the second steel strip 22 facilitates mounting of the first steel strip 12 and the second steel strip 22 to the first body portion 11 and the second body portion 21. In the above embodiment, the case where the first steel strip 12 and the second steel strip 22 are divided into a plurality of pieces in the circumferential direction has been described. However, not limited to this case, at least one of the first steel strip 12 and the second steel strip 22 may be divided into a plurality of pieces in the circumferential direction. Further, the first steel strip 12 and the second steel strip 22, which are not divided, may also be used.

In the above embodiment, the first steel strip 12 and the second steel strip 22 each include the first portion 121, 221 and the second portion 122, 222 arranged side by side in the circumferential direction. The virtual planes S₁, S₂ each containing the end faces 121A, 122A, 221A, 222A of the first portion 121, 221 and the second portion 122, 222 intersect the rotational axis T₁ of the rotary table bearing 1. The virtual planes S₁, S₂ also intersect the rotational axis T₂ of the roller 30. The above configuration adopted in the first portions 121, 221 and the second portions 122, 222 can suppress the dropping of a roller 30 from the boundary between the first portion 121, 221 and the second portion 122, 222, as well as the vibration that may occur when a roller 30 passes through the boundary. The spacing in the circumferential direction between the end face 121A and the end face 122A is set to prevent a roller 30 from entering a gap formed between the end faces 121A and 122A and to allow the rollers 30 to roll smoothly. The spacing in the circumferential direction between the end face 221A and the end face 222A is set in a similar manner.

In the above embodiment, the case where the gear 114 is formed over the entire circumference to include the outer circumferential surface 11D of the first body portion 11 has been described. However, not limited to this case, the gear 114 may be formed over an entire circumference to include the inner circumferential surface 21D of the second body portion 21. In the above embodiment, the case where the outer ring or the inner ring is subjected to grinding to form the gear 114 has been described. However, not limited to this case, a cylindrical member with a gear 114 formed may be fitted into the first body portion 11 or the second body portion 21 to thereby form the gear 114 on the outer circumferential surface of the outer ring 10 or the inner circumferential surface of the inner ring 20.

In the above embodiment, the case where the retainer 40 is divided into a plurality of pieces in the circumferential direction has been described. However, not limited to this, an undivided retainer 40 may also be used.

In the above embodiment, the case where the first body portion 11 and the second body portion 21 are made of steel having a pearlite structure has been described. However, not limited to this, a steel material that has a film formed to include the surface may be used as the material constituting the first body portion 11 and the second body portion 21. Specifically, a steel material such as one having a film composed of manganese phosphate formed thereon, or one having a film containing a solid lubricant such as molybdenum disulfide or the like formed thereon, may be used.

### Embodiment 2

A description will now be made of Embodiment 2 of the rotary table bearing 1 of the present disclosure. The rotary table bearing 1 in Embodiment 2 basically has the same structure and produces the same effects as the rotary table bearing 1 in Embodiment 1. However, Embodiment 2 differs from Embodiment 1 in that the fourth flange portion 56 is configured with a portion of a detachable second member. The points that are different from the case of Embodiment 1 will mainly be described below.

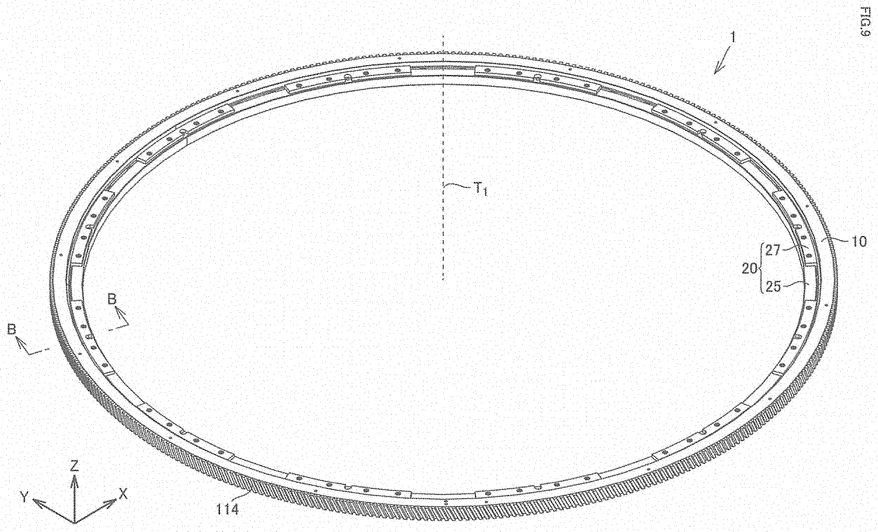

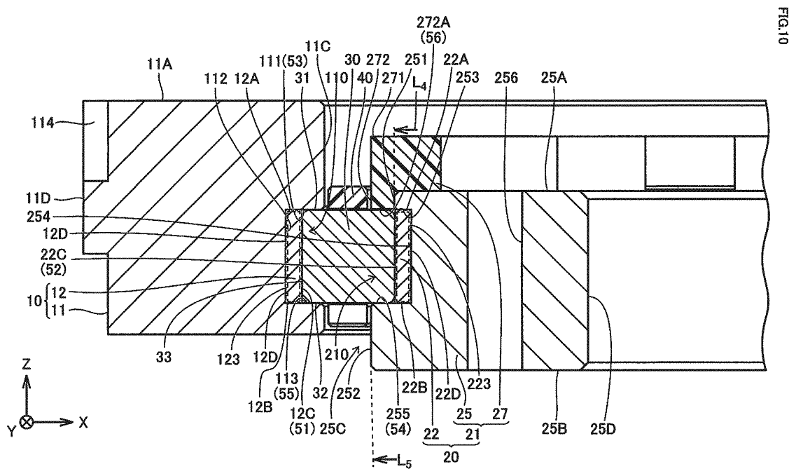

FIG. 9 is a schematic perspective view showing the structure of the rotary table bearing 1 in Embodiment 2. FIG. 10 is a cross-sectional view when cut at B-B in FIG. 9. Referring to FIGS. 9 and 10, the rotary table bearing 1 in Embodiment 2 includes an outer ring 10, an inner ring 20, a plurality of rollers 30, and a retainer 40. The inner ring 20 includes a second body portion 21 and a second steel strip 22.

The second body portion 21 has an annular shape. The second body portion 21 includes a first member 25 and a second member 27. The first member 25 has an annular shape. The first member 25 is made of steel having a pearlite structure. The steel that constitutes the first member 25 in the present embodiment is S45C specified in JIS standard. The first member 25 includes one end face 25A, an end face 25B on the opposite side of the end face 21A in the Z axis direction, an outer circumferential surface 25C, and an inner circumferential surface 25D. The end faces 21A and 21B each have a planar shape. The end face 21A and the end face 21B are arranged in parallel. The inner circumferential surface 25D has a cylindrical surface shape. The outer circumferential surface 25C includes a first region 251 located on the end face 25A side than its center in the Z axis direction, and a second region 252 located on the end face 25B side than its center in the Z axis direction. The first region 251 has an outer diameter L₄ that is smaller than an outer diameter L₅ of the second region 252. The outer circumferential surface 25C has an annularly recessed second concave portion 210 formed between the first region 251 and the second region 252 in the Z axis direction. The second concave portion 210 extends along the circumferential direction of the outer circumferential surface 25C. The second concave portion 210 is defined by a fourth surface 253, a fifth surface 254, and a sixth surface 255, which are of annular shape. The fourth surface 253 and the sixth surface 255 each have a planar shape. The fifth surface 254 has a cylindrical surface shape. The fourth surface 253 and the sixth surface 255 are spaced apart in the Z axis direction. The fourth surface 253 and the sixth surface 255 are arranged in parallel. The sixth surface 255 is located on the end face 25B side in the Z axis direction when viewed from the fourth surface 253. The fifth surface 254 is connected to the inner perimeters of the fourth surface 253 and the sixth surface 255. The fifth surface 254 is arranged along the Z axis direction. The first member 25 has a plurality of screw holes 256 formed at intervals in the circumferential direction to penetrate from the end face 25A to the end face 25B.

The second steel strip 22 has a second inner circumferential surface 22D located to contact the fifth surface 254. The second steel strip 22 has an end face 22A located to contact the fourth surface 253. The second steel strip 22 has an end face 22B located to contact the sixth surface 255.

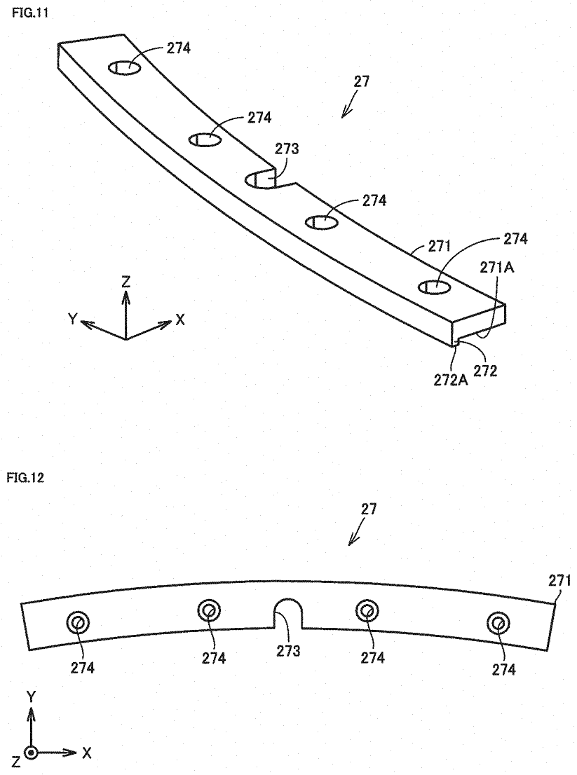

Referring to FIGS. 9 and 10, a plurality of second members 27 are arranged along the circumferential direction of the first member 25. In the present embodiment, the second members are made of resin. Referring to FIGS. 11 and 12, each second member 27 has an arc shape. The second member 27 includes a third portion 271 and a fourth portion 272. The third portion 271 has a flat plate shape. In the third portion 271, a plurality of screw holes 274 penetrating in the thickness direction are formed along the circumferential direction of the first member 25. In the center of the third portion 271 in the circumferential direction of the first member 25, a cutout 273 is formed which has an opening on the inner circumferential surface. The first member 25 has a plurality of screw holes (not shown) formed to correspond to the plurality of screw holes 274. The fourth portion 272 protrudes along the Z axis direction from one end face 271A in the axial direction of the third portion 271. As viewed in a plane in the Z axis direction, the fourth portion 272 is connected so as to include the outer perimeter of the third portion 271. Referring to FIG. 10, the third portion 271 is disposed on the end face 25A of the first member 25. The fourth portion 272 has its inner circumferential surface coming into contact with the first region 251 of the outer circumferential surface 25C. The fourth portion 272 is arranged such that its tip end portion 272A in the Z axis direction faces the first end face 31 of the roller 30. The tip end portion 272A of the fourth portion 272 constitutes the fourth flange portion 56 that protrudes radially outward from the end face 22A side of the second steel strip 22.

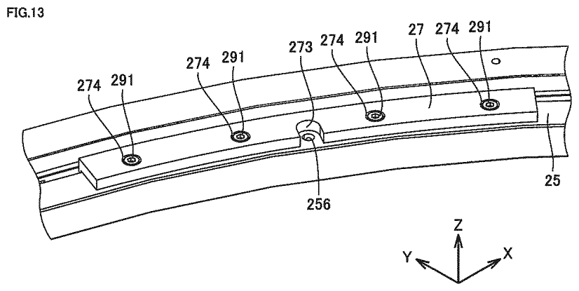

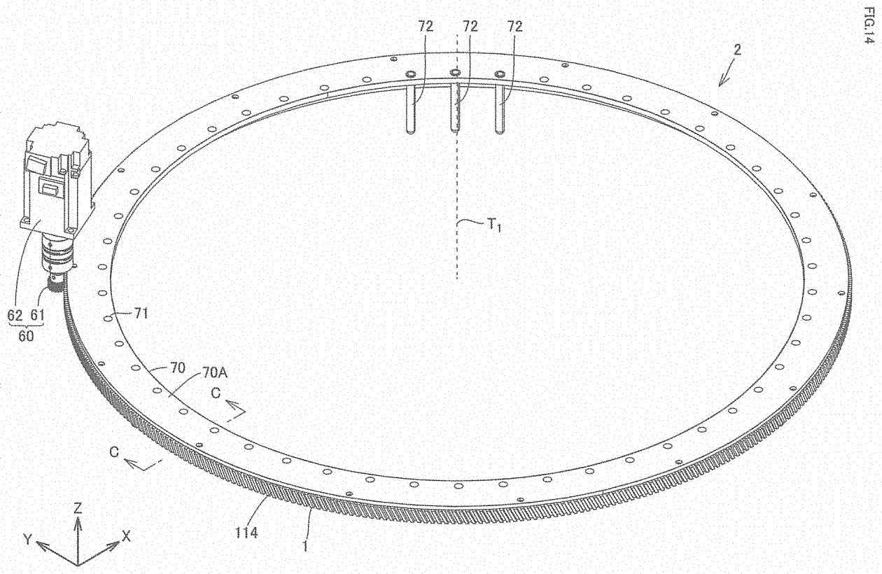

Referring to FIG. 13, a plurality of screws 291 are screwed in the state where the first member 25 is placed on the end face A of the first member 25 such that the positions where the cutouts 256 are formed in the third portion 271 coincide with the positions where the screw hole 256 are formed in the first member 25 and that the positions where the screw holes 274 are formed in the first member 25 coincide with the positions where the screw holes are formed in the first member 25. In this manner, the second member 27 is fixed to the first member 25. By placing or removing the plurality of screws 291, the second member 27 can be attached to or removed from the first member 25. This configuration facilitates the assembly of the rotary table bearing 1.

According to the rotary table bearing 1 of Embodiment 2 above as well, similarly as in Embodiment 1, misalignment of the outer ring 10 with respect to the inner ring 20 in the axial direction and the axial runout can be suppressed, and the production cost can also be reduced.

While the case where the second body portion 21 includes the second member 27 has been described in the above embodiment, not limited to this case, the first body portion 11 may include the second member 27. In such a case, the tip end portion 272A of the fourth portion 272 in the second member 27 constitutes the third flange portion 55 which protrudes radially inward from the end face 12B side of the first steel strip 12. Further, the second member 27 may be detachably attached to the first body portion 11. Both the first body portion 11 and the second body portion 21 may include the second member 27.

### Embodiment 3

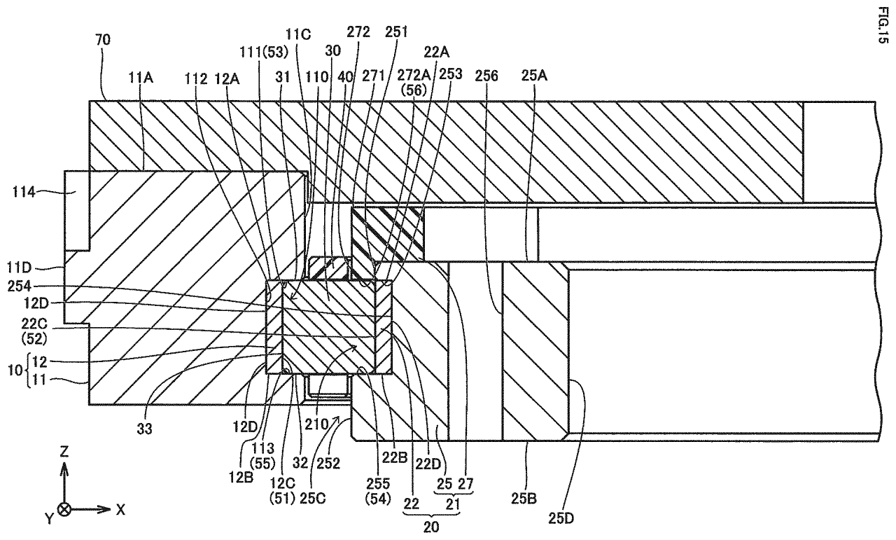

A description will now be made of a rotary table of the present disclosure. FIG. 14 is a schematic perspective view showing the structure of a rotary table in Embodiment 3. FIG. 15 is a cross-sectional view when cut at C-C in FIG. 14. Referring to FIGS. 14 and 15, the rotary table 2 in the present embodiment includes the rotary table bearing 1 in Embodiment 2, a retaining member 70, and a drive unit 60. The second body portion 21 of the inner ring 20 in the rotary table bearing 1 is fixed to a member (not shown) that holds the rotary table bearing 1. The retaining member 70 has a flat annular shape. The retaining member 70 has a plurality of axially penetrating through holes 71 formed at equal intervals in the circumferential direction. The wall surface as a retaining portion surrounding each through hole 71 has a shape capable of retaining a test tube 72.

The drive unit 60 includes a pinion 61 and a motor 62. The drive unit 60 is arranged such that the pinion 61 engages with the gear 114 that is formed to include the outer circumferential surface 11D of the first body portion. As the pinion 61 engages with the gear 114, the outer ring 10 of the rotary table bearing 1 rotates about the rotational axis T₁. This enables the retaining member 70 to rotate about the rotational axis T₁.

As the rotary table 2 in Embodiment 3 above includes the rotary table bearing 1 in Embodiment 2, misalignment of the outer ring with respect to the inner ring in the axial direction and the axial runout can be suppressed, and the production cost can also be reduced. The rotary table of the present disclosure enables stable turning of the retaining member 70.

In the above embodiment, the case of using the rotary table bearing 1 with the gear 114 formed over the entire circumference of the outer circumferential surface of the outer ring 10 has been described. However, a rotary table bearing 1 with a gear 114 formed over an entire circumference of the inner circumferential surface of the inner ring 20 may be used as well. In such a case, the first body portion 11 of the outer ring 10 in the rotary table bearing 1 is fixed to a member (not shown) that holds the rotary table bearing 1. The drive unit 60 is arranged such that the pinion 61 engages with the gear 114 that is formed to include the inner circumferential surface 25D of the first member 25 in the second body portion 21. As the pinion 61 engages with the gear 114, the inner ring 20 of the rotary table bearing 1 rotates about the rotational axis T₁.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: rotary table bearing; 2: rotary table; 10: outer ring; 11: first body portion; 11A, 11B, 12A, 12B, 21A, 21B, 22A, 22B, 25A, 25B, 121A, 122A, 221A, 222A, 271A, A: end face; 11C, 21D, 25D; inner circumferential surface; 11D, 21C, 25C, 33: outer circumferential surface; 12: first steel strip; 12C: first inner circumferential surface; 12D: first outer circumferential surface; 20: inner ring; 21: second body portion; 22: second steel strip; 22C: second outer circumferential surface; 22D: second inner circumferential surface; 25: first member; 27: second member; 30: roller; 31: first end face; 32: second end face; 40: retainer; 41A: protruding portion; 51: first rolling surface; 52: second rolling surface; 53: first flange portion; 54: second flange portion; 55: third flange portion; 56: fourth flange portion; 60: drive unit; 61: pinion; 62: motor; 70: retaining member; 71: through hole; 72: test tube; 110: first concave portion; 111: first surface; 112: second surface; 113: third surface; 114: gear; 121, 221: first portion; 122, 222: second portion; 123, 223: nitrocarburized layer; 210: second concave portion; 211, 251: first region; 212, 252: second region; 213, 253: fourth surface; 214, 254: fifth surface; 215, 255: sixth surface; 216: screw portion; 216A: screw hole portion; 216B: counterbored portion; 256, 274: screw hole; 271: third portion; 272: fourth portion; 272A: tip end portion; 273: cutout; and 291: screw.

1. A bearing for a rotary table, comprising:
an outer ring having an annular first rolling surface;
an inner ring having an annular second rolling surface, the second rolling surface having a common central axis with the first rolling surface, located on an inner circumference side of the outer ring, and facing the first rolling surface; and
a plurality of rollers arranged to be capable of rolling on the first and second rolling surfaces;
the outer ring including
a first body portion of an annular shape, and
a first steel strip of an annular shape held in the first body portion and having a first inner circumferential surface constituting the first rolling surface,
the inner ring including
a second body portion of an annular shape, and
a second steel strip of an annular shape held in the second body portion and having a second outer circumferential surface constituting the second rolling surface,
the first body portion including a first flange portion of an annular shape protruding radially inward from one side in the axial direction of the first steel strip and contacting a first end face which is an end face of the roller in the axial direction,
the second body portion including a second flange portion of an annular shape protruding radially outward from one side in the axial direction of the second steel strip and located to contact a second end face which is an end face of the roller opposite to the first end face in the axial direction,
at least one of an inner circumferential surface of the inner ring and an outer circumferential surface of the outer ring having a gear formed over an entire circumference thereof.

2. The rotary table bearing according to claim 1, wherein
the first body portion further includes a third flange portion protruding radially inward from another side in the axial direction of the first steel strip, the third flange portion being arranged spaced apart from the first flange portion in the axial direction and facing the second end face of the roller, and
the second body portion further includes a fourth flange portion protruding radially outward from another side in the axial direction of the second steel strip, the fourth flange portion being arranged spaced apart from the second flange portion in the axial direction and facing the first end face of the roller.

3. The rotary table bearing according to claim 2, wherein a portion including the third flange portion is detachable with respect to another portion of the first body portion.

4. The rotary table bearing according to claim 2, wherein a portion including the fourth flange portion is detachable with respect to another member of the second body portion.

5. The rotary table bearing according to claim 1, further comprising a retainer configured to retain the plurality of rollers at predetermined intervals.

6. The rotary table bearing according to claim 5, wherein
the retainer has an annular shape,
the retainer has a plurality of cutouts formed at intervals in the circumferential direction, each cutout extending in the axial direction and having an opening at one end face, and
the rollers are retained in the cutouts in such a manner that the rollers and the cutouts correspond one-to-one with each other.

7. The rotary table bearing according to claim 1, wherein at least one of the first and second steel strips is divided into a plurality of pieces in the circumferential direction.

8. The rotary table bearing according to claim 7, wherein
at least one of the first and second steel strips includes a first portion and a second portion arranged side by side in the circumferential direction, and
a virtual plane containing end faces in the circumferential direction of the first and second portions intersects a rotational axis of the rotary table bearing.

9. The rotary table bearing according to claim 1, wherein the outer ring has an outer diameter of at least 400 mm.

10. The rotary table bearing according to claim 1, wherein a region including the first inner circumferential surface of the first steel strip has a hardness of at least 55 HRC, and a region including the second outer circumferential surface of the second steel strip has a hardness of at least 55 HRC.

11. A rotary table comprising:
the rotary table bearing according to claim 1; and
a retaining member disposed on an end face in the axial direction of one of the first and second body portions, the retaining member having retaining portions configured to retain other members at equal intervals in the circumferential direction.
